(19) United States
(12) Patent Application Publication
(10) Pub. No.: US 2005/0087053 A1
(43) Pub. Date: Apr. 28, 2005

(54) Paper trimmer having safety locking device

(76) Inventor: Chang Cheng Yu, Taichung (TW)

Correspondence Address: Chang Cheng YU, P.O.Box 63-298, Taichung, 406, TW

(21) Appl. No.: 10/693,512

(22) Filed: Oct. 22, 2003

(51) Int. Cl. B26D 5/08

(52) U.S. Cl. 83/607

(57) ABSTRACT

A paper trimmer includes a cutter blade attached to a base, a catch attached to the cutter blade and having an orifice, and a latch device having a pole selectively engageable into the orifice of the catch to lock the catch and the cutter blade to the base, and selectively disengageable from the orifice of the catch, to allow the catch to be disengaged from the latch device, and to allow the cutter blade to be opened relative to the base. The catch and the cutter blade may not be operated relative to the base when the pole of the latch device is engaged in the orifice of the base, to prevent the cutter blade from being operated relative to the base by children inadvertently.

### BACKGROUND OF THE INVENTION

1. Field of the Invention

The present invention relates to a paper trimmer, and more particularly to a paper trimmer having a safety locking device to safely lock the cutter blade to the base, and to prevent the cutter blade from being opened relative to the base inadvertently by children.

2. Description of the Prior Art

Typical paper trimmers comprise a cutter blade attached to a base and movable relative to the base for cutting paper sheets or the like.

For example, U.S. Pat. No. 4,957,025 to Beno discloses one of the typical paper trimmers which also comprises a cutter blade attached to a base and movable relative to the base. However, the cutter blade has not been locked to the base, and may then be easily opened by children, such that the children may be hurt or cut by the cutter blade inadvertently.

The present invention has arisen to mitigate and/or obviate the afore-described disadvantages of the conventional paper trimmers.

### SUMMARY OF THE INVENTION

The primary objective of the present invention is to provide a paper trimmer having a safety locking device to safely lock the cutter blade to the base, and to prevent the cutter blade from being opened relative to the base inadvertently by children.

In accordance with one aspect of the invention, there is provided a paper trimmer comprising a base including a side portion, a cutter blade attached to the base, a catch attached to the cutter blade, and including an orifice formed therein, and a latch device including a pole selectively engageable into the orifice of the catch, to lock the catch and the cutter blade to the base, and selectively disengageable from the orifice of the catch, to allow the catch to be disengaged from the latch device, and to allow the cutter blade to be opened relative to the base. The catch and thus the cutter blade may not be opened or rotated or operated relative to the base when the pole of the latch device is engaged in the orifice of the base, to safely lock the cutter blade to the base, and to prevent the cutter blade from being opened or rotated or operated relative to the base.

The base includes a cavity formed in the side portion thereof, a rod is slidably received in the cavity of the base, and secured to the pole of the latch device. A barrel is engaged in the cavity of the base, the barrel includes a bore formed therein to slidably receive the rod. The barrel includes a spring received in the bore thereof, and engaged with the rod, to bias the rod into the bore of the barrel.

The barrel includes an aperture communicating with the bore thereof, to slidably receive the rod and having an inner diameter smaller than that of the bore of the barrel. The barrel includes a peripheral bulge extended radially and outwardly therefrom to engage with the base, and to position the barrel to the base.

The pole of the latch device includes a screw hole formed therein, the rod includes an outer thread formed thereon and threaded with the screw hole of the pole of the latch device, to secure the rod and the latch device together.

The catch includes an opening formed therein and communicating with the orifice of the catch, the orifice of the catch includes an inner diameter greater that that of the opening of the catch, the rod includes an outer diameter smaller than that of the orifice and the opening of the catch, to allow the rod to move out through the opening of the catch.

The catch is rotatably attached to the cutter blade with a pin, the catch includes a hand grip extended therefrom for rotating the catch relative to the cutter blade.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a paper trimmer having a safety locking device in accordance with the present invention;

FIG. 2 is a partial exploded view of the paper trimmer having a safety locking device;

FIG. 3 is an enlarged partial exploded view of the paper trimmer;

FIG. 4 is a partial cross sectional view of the paper trimmer, taken along lines 4-4 of FIG. 1; and

FIGS. 5, 6 are enlarged partial perspective views illustrating the operation of the safety locking device of the paper trimmer.

### DETAILED DESCRIPTION OF THE PREFERRED EMBODIMENT

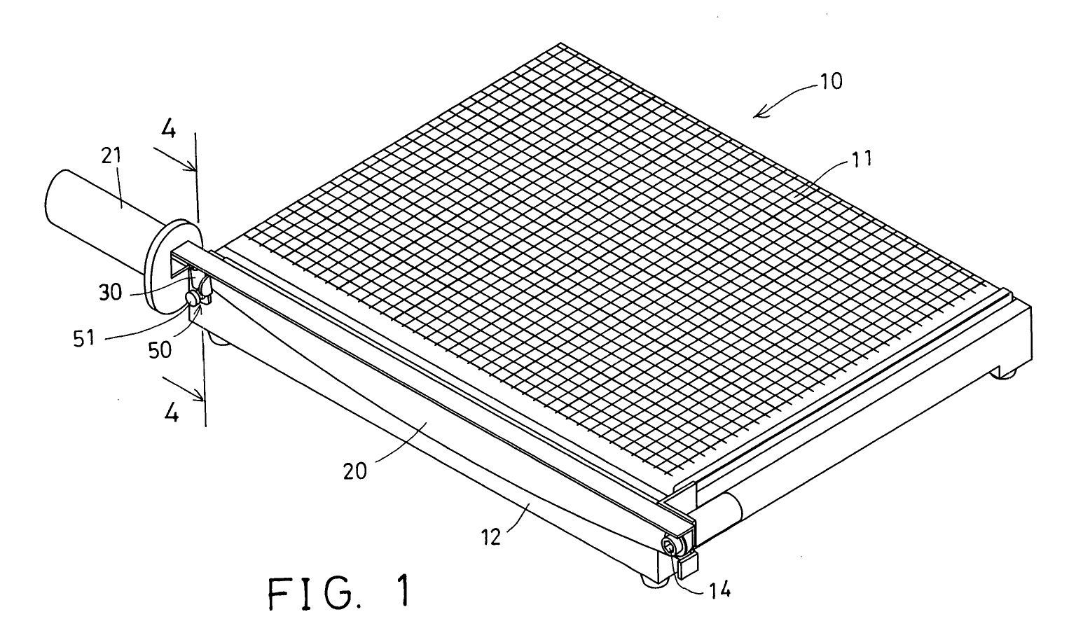

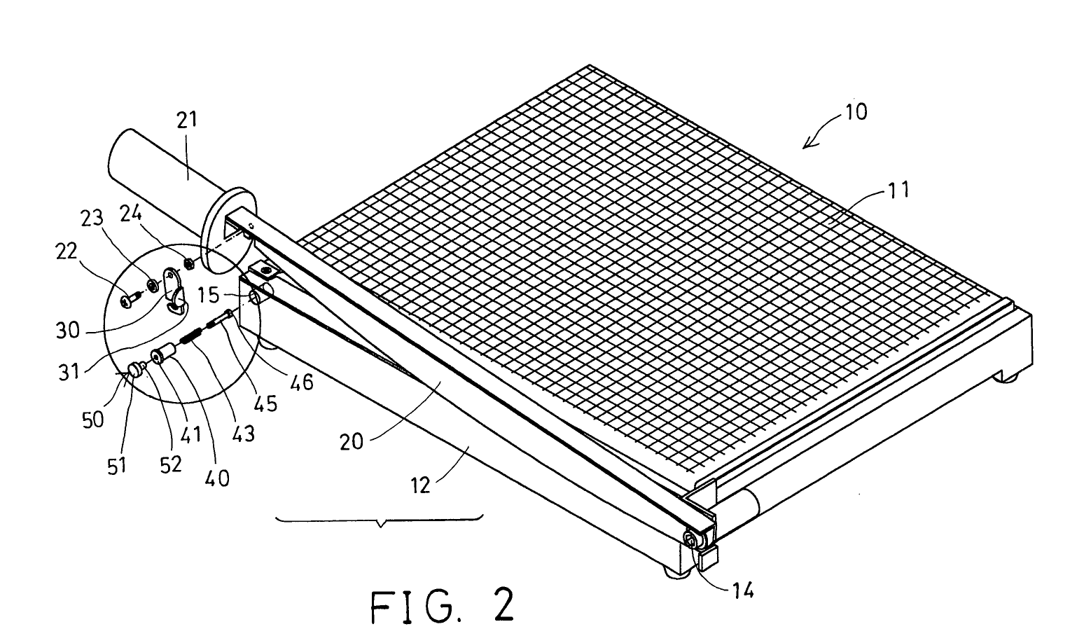

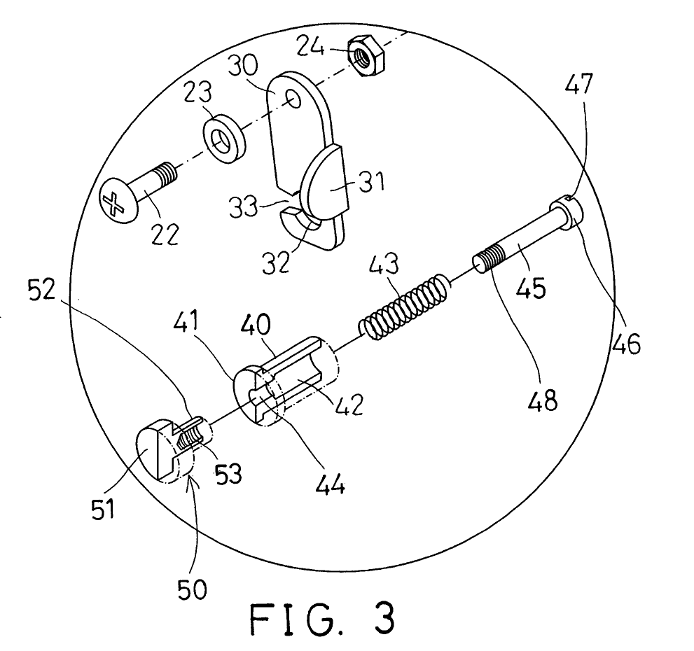

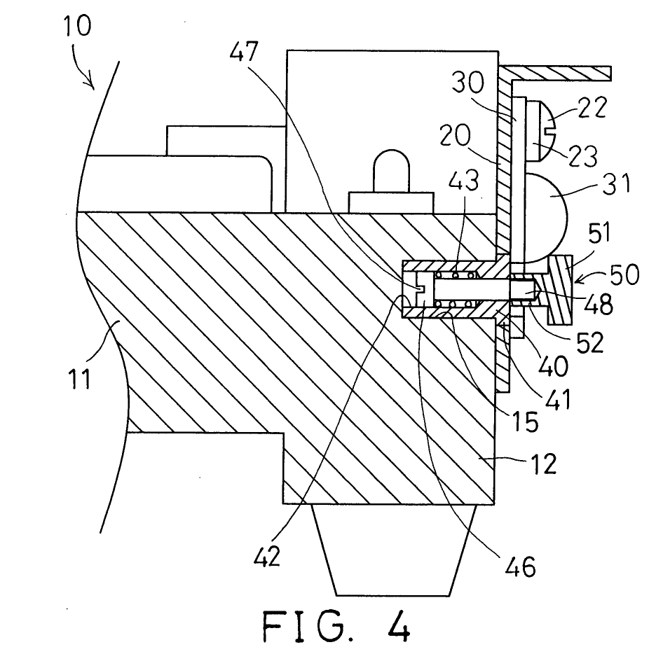

Referring to the drawings, and initially to FIGS. 1-5, a paper trimmer 10 in accordance with the present invention comprises a base 11 including one side portion or side flange 12 having a cavity 15 formed therein, such as formed close to one end thereof.

A cutter blade 20 includes one end rotatably or pivotally attached to the base 11, such as to the other end of the side flange 12 of the base 11, with an axle 14, to allow the cutter blade 20 to be opened or moved relative to the base 11 for cutting paper sheets or the like. The cutter blade 20 includes a handle 21 attached to the other end thereof, and distal to the axle 14, for moving or rotating the cutter blade 20 relative to the base 11, in order to conduct the paper cutting operations.

A catch 30 includes one end rotatably or pivotally attached to the cutter blade 20 with a pin 22 and/or a washer 23 and/or a lock nut 24 or the like, to allow the catch 30 to be rotated or moved relative to the cutter blade 20. The catch 30 includes a hand grip 31 extended therefrom, such as perpendicular to the catch 30, for moving or rotating the catch 30 relative to the cutter blade 20.

The catch 30 further includes an orifice 32 and an opening 33 formed therein, and communicating with each other, and preferably formed in the other end of the catch 30 and located distal to the pin 22. The orifice 32 of the catch 30 includes an inner diameter or a height greater that the height of the opening 33 of the catch 30, and the opening 33 of the catch 30 opens the orifice 32 of the catch 30 outwardly.

A barrel 40 is engaged into the cavity 15 of the base 11, and includes an enlarged or peripheral bulge 41 extended radially and outwardly from one end thereof for engaging with the base 11, and to limit the engagement of the barrel 40 into the cavity 15 of the base 11, and to stably position or retain the barrel 40 to the base 11.

The barrel 40 includes a bore 42 formed therein to receive a spring 43 therein, and includes an aperture 44 formed therein and communicating with the bore 42 thereof. The aperture 44 of the barrel 40 includes an inner diameter smaller than that of the bore 42 of the barrel 40, and smaller than the outer diameter of the spring 43, to prevent the spring 43 from being disengaged from the barrel 40, and to retain the spring 43 within the bore 42 of the barrel 40.

A fastener or a rod 45 is slidably engaged in the bore 42 and the aperture 44 of the barrel 40, and includes an enlarged head 46 extended radially and outwardly from one end or inner end thereof for engaging with the spring 43, and to retain the spring 43 between barrel 40 and the head 46 of the rod 45, such that the spring 43 may bias or force the rod 45 into the barrel 40.

The rod 45 further includes an engaging groove 47 formed therein, such as formed in the head 46 for engaging with driving tools (not shown) which may be used to rotate the rod 46 relative to the barrel 40. The rod 45 includes an outer thread 48 formed therein, such as formed in the other end or outer end thereof, and extendible out through the aperture 44 of the barrel 40.

A latch device 50 is further provided and attached to the base 11, for engaging with the catch 30, and to safely lock the catch 30 and the cutter blade 20 to the base 11. The latch device 50 includes a knob 51 and a pole 52 extended from the knob 51, and includes an inner thread or a screw hole 53 formed therein for threading with the outer thread 48 of the rod 45, and for securing the latch device 50 to the rod 45.

The pole 52 of the latch device 50 includes an outer diameter greater than the inner diameter of the aperture 44 of the barrel 40, to allow the pole 52 of the latch device 50 to be engaged with the peripheral bulge 41 of the barrel 40, and thus to be extended and retained outwardly of the side flange 12 of the base 11.

In addition, the pole 52 of the latch device 50 includes an outer diameter smaller than the inner diameter of the orifice 32 of the catch 30, but greater than the height of the opening 33 of the catch 30, and thus to allow the pole 52 of the latch device 50 to be stably retained within the orifice 32 of the catch 30, and to prevent the pole 52 of the latch device 50 from being moved or disengaged from the catch 30 via the opening 33 of the catch 30.

The rod 45 includes an outer diameter smaller than the inner diameter of the orifice 32 of the catch 30, and also smaller than the height of the opening 33 of the catch 30, and thus to allow the rod 45 to be moved or disengaged from the catch 30 via the opening 33 of the catch 30.

In operation, as shown in FIGS. 1, 4, 6, when the pole 52 of the latch device 50 is engaged in and stably retained within the orifice 32 of the catch 30, due to the greater diameter of the pole 52 of the latch device 50 than the opening 33 of the catch 30, the pole 52 of the latch device 50 may not be moved or disengaged from the catch 30 via the opening 33 of the catch 30, such that the pole 52 of the latch device 50 may be stably retained within the orifice 32 of the catch 30, and such that the cutter blade 20 may be stably locked to the base 11 with the catch 30 and the latch device 50.

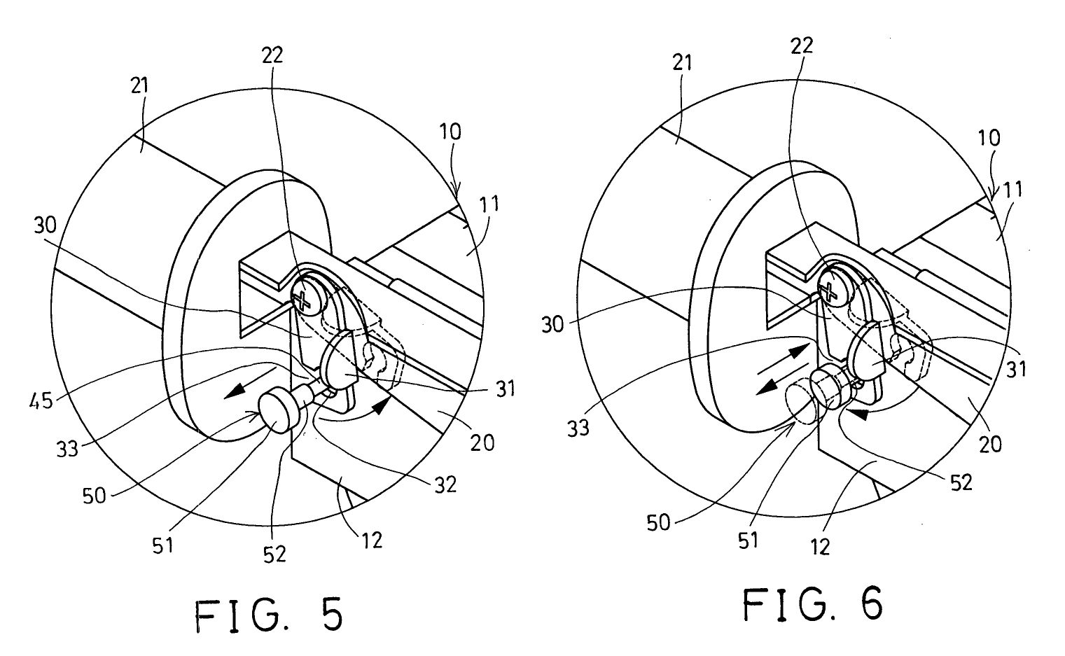

As shown in FIG. 5, when the latch device 50 is pulled outwardly relative to the base 11 and the barrel 40 against the spring 43, the pole 52 of the latch device 50 may be moved and disengaged from the orifice 32 of the catch 30, and thus to allow the rod 45 to be received or engaged within the orifice 32 of the catch 30.

Due to the smaller outer diameter of the rod 45 than the inner diameter or the height of the opening 33 of the catch 30, the rod 45 may be moved or disengaged from the catch 30 via the opening 33 of the catch 30, by rotating the catch 30 relative to the base 11 and the latch device 50, and thus to allow the cutter blade 20 to be opened or rotated or operated relative to the base 11, only when the pole 52 of the latch device 50 is disengaged from the orifice 32 of the catch 30, or when the rod 45 is received or engaged within the orifice 32 of the catch 30.

When the pole 52 of the latch device 50 is stably retained within the orifice 32 of the catch 30, to stably lock the cutter blade 20 to the base 11, the catch 30 may not be easily rotated relative to the cutter blade 20, such that the cutter blade 20 may not be opened and operated by children inadvertently.

Accordingly, the paper trimmer includes a locking device to safely lock the cutter blade to the base and to prevent the cutter blade from being opened relative to the base inadvertently by children.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A paper trimmer comprising:
a base including a side portion having a cavity formed therein,
a cutter blade attached to said base,
a catch rotatably attached to said cutter blade with a pin, and including an orifice formed therein, and said catch including an opening formed therein and communicating with said orifice of said catch, said orifice of said catch including an inner diameter greater that that of said opening of said catch, and said catch including a hand grip extended therefrom for rotating said catch relative to said cutter blade,
a latch device including a pole selectively engageable into said orifice of said catch, to lock said catch and said cutter blade to said base, and selectively disengageable from said orifice of said catch, to allow said catch to be disengaged from said latch device, and to allow said cutter blade to be opened relative to said base,
a rod slidably received in said cavity of said base, and secured to said pole of said latch device, said rod including an outer diameter smaller than that of said orifice and said opening of said catch, to allow said rod to move out through said opening of said catch, and
means for biasing said pole to engage into said orifice of said catch.

2. (canceled).

3. The paper trimmer as claimed in claim 1 further comprising a barrel engaged in said cavity of said base, said barrel including a bore formed therein to slidably receive said rod.

4. The paper trimmer as claimed in claim 3, wherein said biasing means includes a spring received in said bore of said barrel, and engaged with said rod, to bias said rod into said bore of said barrel.

5. The paper trimmer as claimed in claim 3, wherein said barrel includes an aperture formed therein and communicating with said bore thereof, to slidably receive said rod, said aperture of said barrel includes an inner diameter smaller than that of said bore of said barrel.

6. The paper trimmer as claimed in claim 3, wherein said barrel includes a peripheral bulge extended radially and outwardly therefrom to engage with said base, and to position said barrel to said base.

7. The paper trimmer as claimed in claim 1, wherein said pole of said latch device includes a screw hole formed therein, said rod includes an outer thread formed thereon and threaded with said screw hole of said pole of said latch device, to secure said rod and said latch device together.

8-9. (canceled).
